(19) United States
(12) Patent Application Publication
(10) Pub. No.: US 2016/0338087 A1
(43) Pub. Date: Nov. 17, 2016

(54) BACKHAUL SCHEDULING IN MULTI-HOP SYSTEM

(71) Applicant: NOKIA SOLUTIONS AND NETWORKS OY, Espoo (FI)

(72) Inventors: Rapeepat Ratasuk, Hoffman Estates, IL (US); Mark Cudak, Rolling Meadows, IL (US); Frederick Vook, Schaumburg, IL (US); Amitabha Ghosh, Buffalo Grove, IL (US); Jun Tan, Lake Zurich, IL (US)

(21) Appl. No.: 15/111,433

(22) PCT Filed: Jan. 14, 2014
(86) PCT No.: PCT/US2014/011423

§ 371 Date: Jul. 13, 2016

(51) Int. Cl. H04W 72/12; H04W 72/04

(52) U.S. Cl. CPC H04W 72/1263; H04W 72/0446; H04W 72/0413; H04W 72/042; H04W 84/042

(57) ABSTRACT

Systems, methods, apparatuses, and computer program products for backhaul scheduling in a multi-hop network are provided. One method includes providing, in the multi-hop network, an uplink control portion and a downlink control portion and a data portion in a slot. The method may further include scheduling, by an access point in the multi-hop network, at least one of a backhaul transmission for the slot or at least one following slot or an access transmission for the slot.

### BACKGROUND

1. Field

Certain embodiments generally relate to communication systems and, in particular, may relate to a multi-hop network such as, but not limited to, a millimeter wave (mmWave) communication system.

2. Description of the Related Art

A global bandwidth shortage facing wireless carriers has motivated the consideration of the underutilized millimeter wave (mmWave) frequency spectrum for future broadband cellular communication networks. mmWave (or extremely high frequency) generally refer to the frequency range between 30 and 300 gigahertz (GHz). This is the highest radio frequency band in practical use today. Radio waves in this band have wavelengths from ten to one millimeter, giving it the name millimeter band or millimeter wave.

The amount of wireless data might increase one thousand fold over the next ten years. Essential elements in solving this challenge include obtaining more spectrum, having smaller cell sizes, and using improved technologies enabling more bits/s/Hz. An important element in obtaining more spectrum is to move to higher frequencies, above 6 GHz. For fifth generation wireless systems (5G), an access architecture for deployment of cellular radio equipment employing mmWave radio spectrum has been proposed. In addition to extending cellular service into the mmWave band, dynamic spectrum access is an important technique to improve spectrum utilization.

### SUMMARY

One embodiment is directed to a method comprising providing, in a multi-hop network, an uplink control portion and a downlink control portion and a data portion in a slot. The method may further comprise scheduling, by an access point in the multi-hop network, at least one of a backhaul transmission for said slot or at least one following slot or an access transmission for said slot.

Another embodiment is directed to an apparatus comprising at least one processor and at least one memory including computer program code. The at least one memory and the computer program code are configured, with the at least one processor, to cause the apparatus at least to provide, in a multi-hop network, an uplink control portion and a downlink control portion and a data portion in a slot, and to schedule at least one of a backhaul transmission for said slot or at least one following slot or an access transmission for said slot.

Another embodiment is directed to an apparatus comprising means for providing, in a multi-hop network, an uplink control portion and a downlink control portion and a data portion in a slot. The apparatus may further comprise means for scheduling at least one of a backhaul transmission for said slot or at least one following slot or an access transmission for said slot.

Another embodiment is directed to a computer program, embodied on a computer readable medium, the computer program is configured to control a processor to perform a process. The process may comprise providing, in a multi-hop network, an uplink control portion and a downlink control portion and a data portion in a slot, and scheduling, by an access point in the multi-hop network, at least one of a backhaul transmission for said slot or at least one following slot or an access transmission for said slot.

### BRIEF DESCRIPTION OF THE DRAWINGS

For proper understanding of the invention, reference should be made to the accompanying drawings, wherein:

FIG. 1 illustrates an example backhaul configuration, according to an embodiment;

FIG. 2 illustrates an example slot structure, according to one embodiment;

FIG. 3 illustrates example backhaul scheduling with alternating Downlink/Uplink (DL/UL) control portions, according to one embodiment;

FIG. 4 illustrates an example flow diagram of a method, according to one embodiment;

FIGS. 5(a) and 5(b) illustrate two different alternative slot configurations with alternating backhaul assignment, according to an embodiment;

FIG. 6 illustrates an example of an alternative slot configuration with staggered backhaul assignment, according to an embodiment; and

FIG. 7 illustrates a block diagram of an apparatus, according to one embodiment.

### DETAILED DESCRIPTION

It will be readily understood that the components of the invention, as generally described and illustrated in the figures herein, may be arranged and designed in a wide variety of different configurations. Thus, the following detailed description of the embodiments of systems, methods, apparatuses, and computer program products for backhaul scheduling in a wideband radio system such as, but not limited to, a mmWave 5G system, as represented in the attached figures, is not intended to limit the scope of the invention, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments. Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

As will be discussed in detail below, certain embodiments of the invention provide forward scheduling of backhaul transmission where the backhaul and access share the same band. One embodiment provides a tier-based scheduling method where a backhaul transmission is forwarded to another time slot based on its tier. This makes changing the number of access points in the connection path flexible. Another embodiment provides a fixed-field based scheduling method where a scheduling assignment contains a field to indicate the value k. In this case, there will be no need to distinguish assignments for access and backhaul, and also for different tiers. Another embodiment provides different combinations of fixed-field based and tier-based scheduling.

As mentioned above, for 5G, access architecture for deployment of cellular radio equipment employing millimeter wave (mmWave) radio spectrum has been proposed. The availability of enormous bandwidth (e.g., 13 GHz in the 70-80 GHz band) coupled with the use of large antenna arrays with as many as 8 to 64 elements (9 to 18 dB in link budget gain) at both the transmitter and receiver can make this band attractive for deploying high capacity 5G networks.

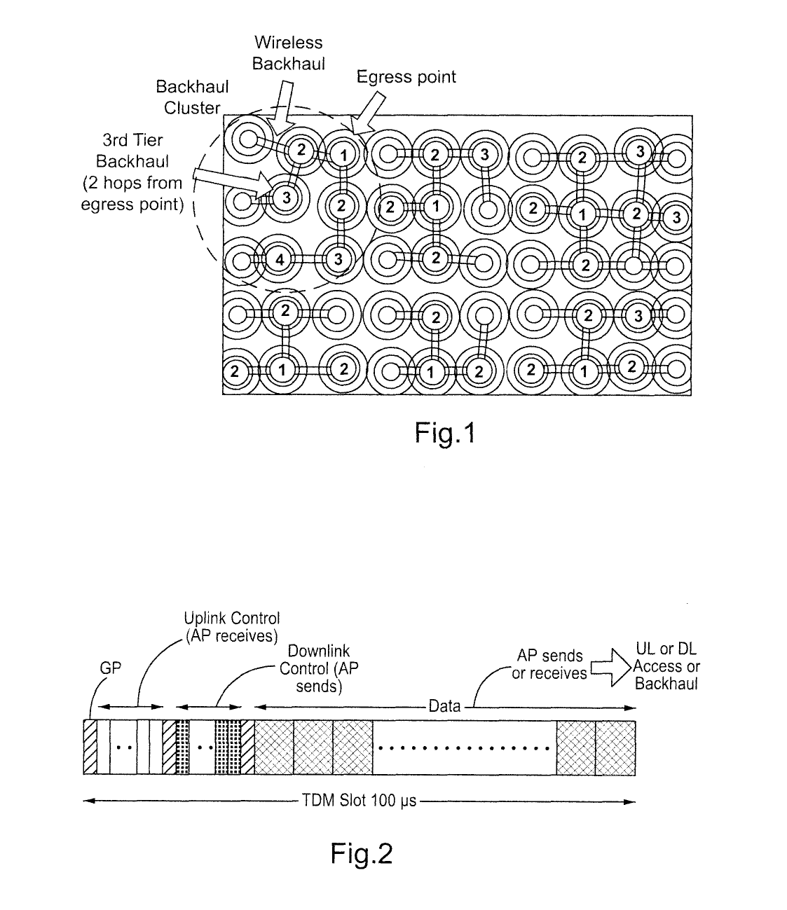

However, the range of mmWave Access Point (AP) is limited, so a large number of them may be required to cover an area. In this case, it may not be practical to provide wired backhaul to all APs. Thus, there may only be a few direct connections to the network (egress points). Other APs in the mmWave system can access the network via a wireless backhaul link as illustrated in FIG. 1. To save cost, access and wireless backhaul may share the same band (i.e., in-band backhaul). It is noted that there may be multiple hops between a certain AP and the egress point. In a radio or cellular communications network, backhaul typically provides means for communications between a radio network and a core network and/or means for communications between different access points in the radio network.

FIG. 1 illustrates an example backhaul configuration with the location of the APs and associated backhaul links, according to an embodiment. Each egress point is identified by a (1) as the first-tier backhaul cell master. All APs one hop away from the egress point become subordinates on the second-tier backhaul. This means that the first-tier backhaul cell master has priority in scheduling the subordinates for backhaul transmission before the subordinates can schedule their slots. Furthermore, all APs one hop away from the egress point will be become second-tier backhaul cell masters if there are any other connected APs further away from the egress point. All second-tier backhaul cell masters are denoted by a (2). Similarly, the third-tier and fourth-tier backhaul cell masters are denoted by a (3) and (4), respectively. It is noted that in this particular example, there are no APs more than 4 hops away from the egress point, but the concept described herein can be used for any number of tiers. In other words, certain embodiments are not necessarily limited to the example configuration illustrated in FIG. 1.

Because, in the case of in-band backhaul, backhaul and access share the same band, there is a problem of when backhaul and access can be scheduled. Generally, this problem is solved by having semi-static configuration of which slots are reserved for backhaul and which slots are reserved for access. However, this is not optimal because of high-latency as AP must wait for the right slot type before scheduling, slots are wasted if there is no data of the right type (access or backhaul), and configuration cannot change rapidly to handle dynamic traffic pattern.

The proposed 5G mmWave system uses time division duplex (TDD) with the slot structure illustrated in FIG. 2. In the example of FIG. 2, the slot is comprised of an uplink control portion, followed by a downlink control portion, followed by a data portion. As depicted in FIG. 2, the data portion is dynamic and can be used for either UL (transmission to the AP) or DL (transmission from the AP) as well as for access or backhaul. This slot structure allows backhaul or access to be scheduled by the AP dynamically, thus eliminating the drawbacks with semi-static configuration. In mmWave, very directional and narrow-beam transmission will be used so there is no interference issue expected between supporting UL and DL simultaneously on different cells.

However, with a slot structure as illustrated in FIG. 2 there is a possible scheduling contention between access and backhaul. The problem is that in a multi-hop network, before the m^{th}-tier AP can schedule a slot, it must know whether it is being scheduled by (m−1)^{th}-tier AP for backhaul transmission in that same slot.

Thus, a backhaul scheduling method is needed to enable there is no such scheduling contention or ambiguity while providing fast and dynamic ability to schedule backhaul transmission. In other words, there is a need to provide priority mechanism where backhaul transfers take precedence over access transfer. Similarly, the 1^{st} Tier backhaul AP should have priority over the 2^{nd} Tier backhaul APs, etc. A mechanism should exist to enable a larger transfer to be pipelined to make best possible use of the data slots for a large transfer.

Certain embodiments may be applicable to a multi-hop system with one egress point and tiers of APs. In an embodiment, the egress point may have wired backhaul to the network while tiered APs may have wireless backhaul connection to the previous tier. Access and backhaul may share the same band to save cost, i.e., in-band backhaul. In an embodiment, the m^{th}-tier AP may schedule (m+1)^{th}-tier AP for backhaul. For example, 2^{nd}-tier AP schedules 3^{rd}-tier AP.

One embodiment provides switching of the uplink and downlink control portions in a slot between tiers to allow receiving of grant from previous tier AP. The slot format may be based on the AP's tier in the multi-hop network. An embodiment provides forward scheduling of backhaul grant—grant given in subframe n will be valid for subframe n+k, where the parameter k, k≧0, may depend on the total number of tiers and the tier of the AP. According to one embodiment, access grant is valid in the same subframe it is given in. In one embodiment, APs could pre-allocate subsequent hops prior to actually receiving the forwarded data packet. The forwarding information may be embedded in the backhaul control. It should be appreciated that a tier may mean an order of an access point in a (hierarchical) communications system in relation to an egress point, the egress point being thought as a 1^{st} tier access node.

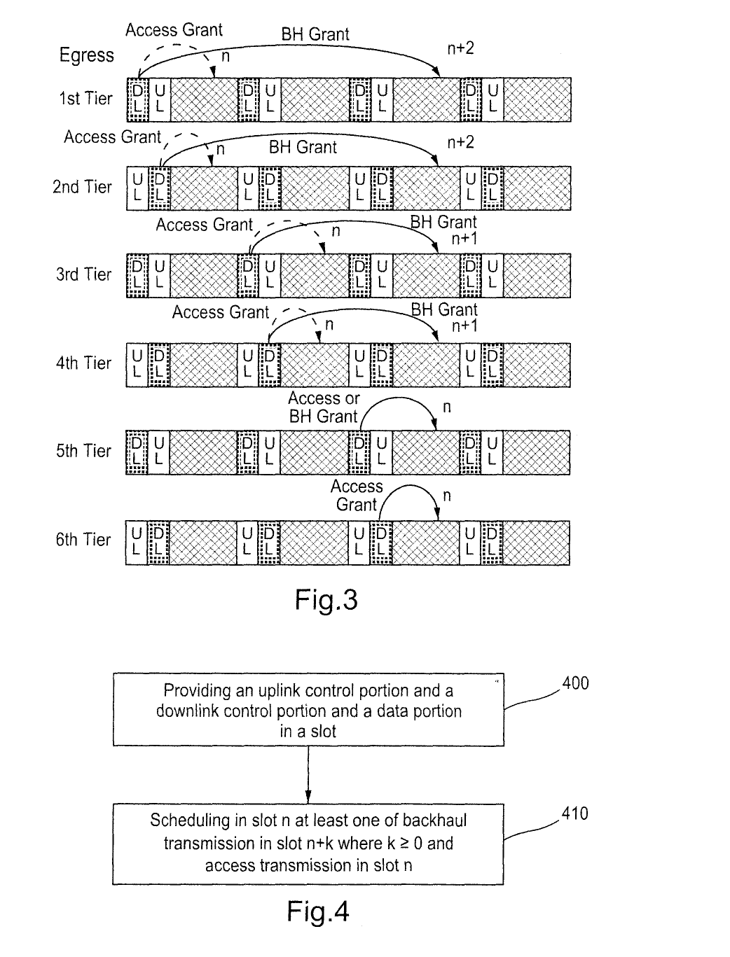

FIG. 3 illustrates example backhaul scheduling with alternating DL/UL control portions, according to one embodiment. In the example of FIG. 3, there are six tiers (i.e., five hops) within the backhaul cluster. However, embodiments are equally applicable to a network with any number of tiers and are not limited to the specific example of FIG. 3.

In FIG. 3, the first-tier AP may schedule backhaul transmission ahead by 2 subframes. The second-tier AP may receive the scheduling grant in the same slot due to DL/UL control switching It therefore can also schedule backhaul transmission ahead of 2 subframes. The third-tier AP may receive the scheduling in the same slot, but it cannot schedule until the next slot, so it schedules backhaul transmission ahead by 1 subframe. This process continues until the last AP can schedule access. If we ignore data decoding time for illustrative purpose, the latency seen by the UE in the 6^{th} tier AP would be 12 slots. However, if pre-allocation is done, then the latency can be reduced to 8 slots.

FIG. 4 illustrates an example of a flow diagram of a method, according to one embodiment. In some embodiments, the method illustrated in FIG. 4 may be performed by an AP, for example, in a multi-hop network. The method may include, at 400, providing an uplink control portion and a downlink control portion and a data portion in a slot. The method may then include, at 410, scheduling by the AP in slot n at least one of backhaul transmission (typically a transmission between access nodes) in at least one following slot n+k where k≧0 and access transmission (typically a transmission between an access node and a user device) in slot n. The at least one following slot n+k may be an immediately following slot or a later slot. Typically, scheduling is for or in one slot but it may be carried out for or in a plurality of slots, too. In an embodiment, the scheduling may include determining by the AP the slot format based on its tier in the multi-hop network. According to one embodiment, the AP determines the value of k based on its tier and the total number of tiers in the multi-hop network. In certain embodiments, the m^{th}-tier AP may schedule backhaul transmission for (m+1)^{th}-tier AP after receiving the scheduling assignment from (m−1)^{th}-tier AP, but prior to receiving the data packet. The scheduling assignment may contain forwarding information regarding the data packet. In one embodiment, backhaul transmission is between AP and AP, and access transmission is between AP and UE.

In another embodiment, the scheduling assignment may contain a field to indicate the value k. In this case, there will be no need to distinguish assignments for access and backhaul, and also for different tiers. In another embodiment, the subframe format (UL+DL+Data or DL+UL+Data) is signaled to the UE during system information acquisition. This can be explicit, for example, using the Physical Broadcast Channel (PBCH) or primary synchronization signal (PSS)/secondary synchronization signal (SSS) or implicit, for example, using PSS/SSS placement or timing difference.

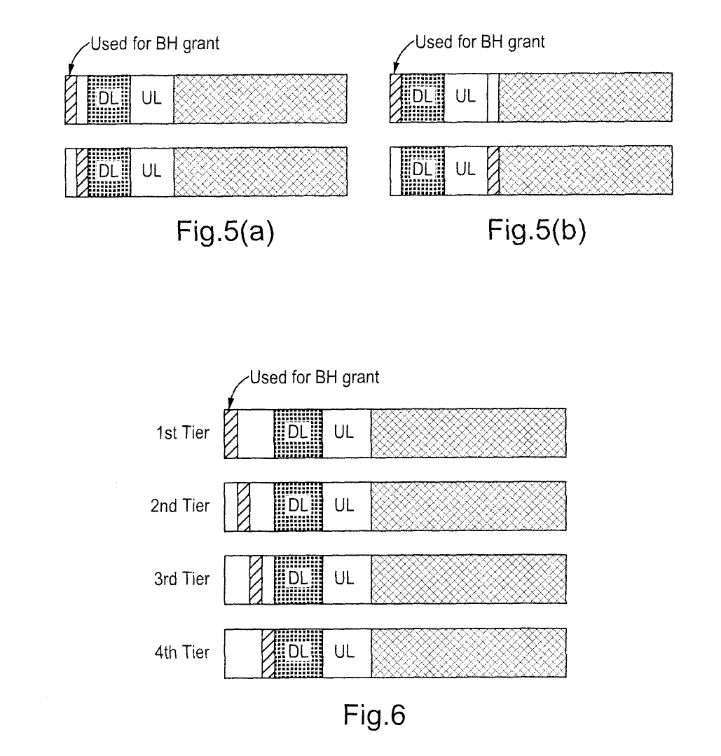

In yet another embodiment, an alternative control structure is used where only DL/UL portions for backhaul assignment is switched while other control portions remain fixed, as illustrated in FIG. 5. In particular, FIG. 5 illustrates two different alternative slot configurations with alternating backhaul assignment, according to an embodiment. FIG. 5(a) illustrates the second backhaul scheduling assignment immediately after the first one. While FIG. 5(b) illustrates the second backhaul scheduling assignment at the end of the control portion to allow for longer processing time by the eNB if needed.

According to another embodiment, an alternative control structure may be used where a staggered backhaul assignment is supported among the tiers while other control portions remain fixed. FIG. 6 illustrates an example of such an alternative slot configuration with staggered backhaul assignment, according to an embodiment. This option allows the backhaul to be scheduled in the same subframe as access (i.e., k=0), thus reducing the delay at the expense of higher overhead.

In another embodiment, the AP may determine its tier based on signaling from the network or based on information from AP of the previous tier. In an embodiment, with the attachment of another AP to the last tier, the last-tier AP indicates to the previous-tier AP of an attachment by an AP. This information is cascaded up along to the first-tier AP and the parameter k is updated by all APs.

In some embodiments, the functionality of any of the methods described herein, such as those illustrated in FIG. 4 discussed above, may be implemented by software and/or computer program code or portions of it stored in memory or other computer readable or tangible media, and executed by a processor. In some embodiments, the apparatus may be, included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of it may be in a source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that can be carried by an electromagnetic signal downloaded from the Internet or other network.

According to an embodiment, apparatus, such as a node, device, or a corresponding component, may be configured as a computer or a microprocessor, such as single-chip computer element, or as a chipset, including at least a memory for providing storage capacity used for arithmetic operation and an operation processor for executing the arithmetic operation.

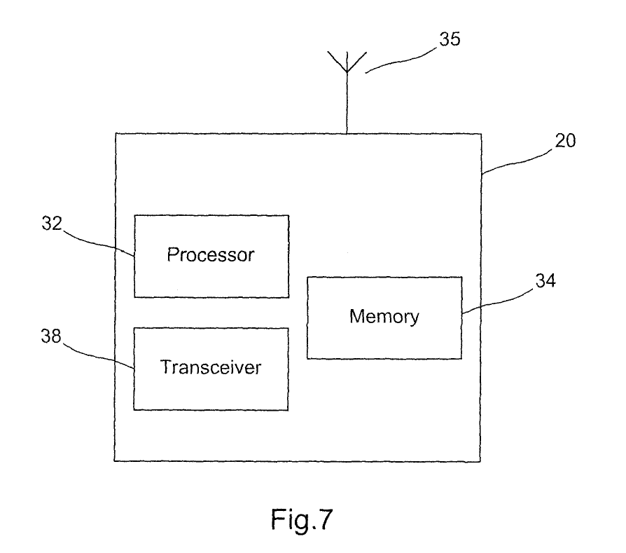

FIG. 7 illustrates an example of an apparatus 20 according to an embodiment. In an embodiment, apparatus 20 may be a base station, node, host, or server in a communications network or serving such a network, such as a node in a radio system. It should be noted that one of ordinary skill in the art would understand that apparatus 20 may include components or features not shown in FIG. 7. As illustrated in FIG. 7, apparatus 20 may include a processor 32 for processing information and executing instructions or operations. Processor 32 may be any type of general or specific purpose processor. While a single processor 32 is shown in FIG. 7, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further comprise or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 may be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

Apparatus 20 may also comprise or be coupled to one or more antennas 35 for transmitting and receiving signals and/or data to and from apparatus 20. Apparatus 20 may further comprise or be coupled to a transceiver 38 configured to transmit and receive information. The transceiver may be an external device, such as a remote radio head. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be an access point (AP), that is any server, node or host or base station in a communications network or serving such a network , such as an AP in a 5G radio system. In this embodiment, apparatus 20 may be controlled by memory 34 and processor 32 to provide an uplink control portion and a downlink control portion and a data portion in a slot. Apparatus 20 may then be controlled by memory 34 and processor 32 to schedule in slot n at least one of backhaul transmission in slot n+k, where k≧0, and access transmission in slot n. In an embodiment, apparatus 20 may be controlled by memory 34 and processor 32 to determine the slot format based on its tier in the multi-hop network. According to one embodiment, apparatus 20 may be controlled by memory 34 and processor 32 to determine the value of k based on its tier and the total number of tiers in the multi-hop network. In certain embodiments, the m^{th}-tier AP may schedule backhaul transmission for (m+1)^{th}-tier AP after receiving the scheduling assignment from (m−1)^{th}-tier AP, but prior to receiving the data packet. The scheduling assignment may contain forwarding information regarding the data packet. In one embodiment, backhaul transmission is to be carried out between AP and AP, and access transmission is between AP and UE.

As illustrated in FIG. 7, apparatus 20 may comprise means for providing an uplink control portion and a downlink control portion and a data portion in a slot. Apparatus 20 may also include means for scheduling in slot n at least one of backhaul transmission in slot n+k, where k≧0, and access transmission in slot n. In an embodiment, apparatus 20 may further comprise means for determining the slot format based on its tier in the multi-hop network. According to one embodiment, apparatus 20 may also comprise means for determining the value of k based on its tier and the total number of tiers in the multi-hop network. In certain embodiments, the m^{th}-tier AP may schedule backhaul transmission for (m+1)^{th}-tier AP after receiving the scheduling assignment from (m−1)^{th}-tier AP, but prior to receiving the data packet. The scheduling assignment may contain forwarding information regarding the data packet. In one embodiment, backhaul transmission is to be carried out between AP and AP, and access transmission is between AP and UE.

Embodiments provide advantages, for example, contention-free access and backhaul scheduling as well as reduced latency One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method, comprising:
providing, in a multi-hop network, an uplink control portion and a downlink control portion and a data portion in a slot ; and
scheduling, by an access point in the multi-hop network, at least one of: a backhaul transmission for the slot, at least one following slot or an access transmission for the slot.

2. The method according to claim 1, further comprising determining a slot format based on a tier of the access point in the multi-hop network.

3. The method according to claim 1, further comprising:
determining the slot which the backhaul transmission is scheduled for based on a tier of the access point in the multi-hop network and a total number of tiers in the multi-hop network.

4. The method according to claim 1, wherein a m^{th}-tier access point schedules backhaul transmission for a (m+1)^{th}-tier access point after receiving a scheduling assignment from a (m−1)^{th}-tier access point but prior to receiving a data packet.

5. The method according to claim 4, further comprising:
preparing a scheduling assignment comprising the scheduling, and forwarding information regarding a data packet in the data portion.

6. The method according to claim 4, wherein the scheduling assignment comprises a field to indicate the slot which the backhaul transmission is scheduled for.

7. The method according to claim 1, wherein the backhaul transmission is to be carried out between the access point in the multi-hop network and a second access point in the multi-hop network, and the access transmission is between the access point in the multi-hop network and a user device.

8. The method according to claim 2, further comprising:
signaling the slot format to the user device during system information acquisition.

9. The method according to claim 1, further comprising:
determining, by the access point, its tier based on signaling from the multi-hop network or based on information from an access point in the multi-hop network of a previous tier.

10. The method according to claim 1, wherein, with an attachment of another access point to the last tier, the last-tier access point indicates to the previous-tier access point of the attachment by the another access point.

11. An apparatus, comprising:
at least one processor; and
at least one memory including computer program code,
wherein the at least one memory and the computer program code are configured, with the at least one processor, to cause the apparatus at least to:
provide, in a multi-hop network, an uplink control portion and a downlink control portion and a data portion in a slot; and
schedule at least one of: a backhaul transmission for the slot, at least one following slot, or an access transmission for the slot.

12. The apparatus according to claim 11, wherein the apparatus comprises an access point.

13. The apparatus according to claim 11, wherein the at least one memory and the computer program code are further configured, with the at least one processor, to cause the apparatus at least to determine the slot format based on a tier of the access point in the multi-hop network.

14. The apparatus according to claim 11, wherein the at least one memory and the computer program code are further configured, with the at least one processor, to cause the apparatus at least to determine the value of k based on a tier of the access point and a total number of tiers in the multi-hop network.

15. The apparatus according to claim 11, wherein a m^{th}-tier access point schedules backhaul transmission for a (m+1)^{th}-tier access point after receiving a scheduling assignment from a (m−1)^{th}-tier access point but prior to receiving a data packet.

16. The apparatus according to claim 15, wherein the scheduling assignment comprises forwarding information regarding the data packet.

17. The apparatus according to claim 15, wherein the scheduling assignment comprises a field to indicate a value k.

18. The apparatus according to claim 11, wherein the backhaul transmission is between the access point and a second access point, and the access transmission is between the access point and a user device.

19. The apparatus according to claim 11, wherein the at least one memory and the computer program code are further configured, with the at least one processor, to cause the apparatus at least to signal the subframe format to the user device during system information acquisition.

20. The apparatus according to claim 11, wherein the at least one memory and the computer program code are further configured, with the at least one processor, to cause the apparatus at least to determine a tier of the apparatus based on signaling from the multi-hop network or based on information from an access point of a previous tier.

21. The apparatus according to claim 11, wherein, with an attachment of another access point to the last tier, the last-tier access point indicates to the previous-tier access point of the attachment by said another access point.

22-23. (canceled)

24. A computer program, embodied on a computer readable medium, the computer program configured to control a processor to perform a process, comprising:
providing, in a multi-hop network, an uplink control portion and a downlink control portion and a data portion in a slot; and
scheduling, by an access point in the multi-hop network, at least one of: a backhaul transmission for the slot, at least one following slot or an access transmission for the slot.
